(19) United States
(12) Patent Application Publication
(10) Pub. No.: US 2004/0227980 A1
(43) Pub. Date: Nov. 18, 2004

(54) Scan method capable of enhancing scan quality

(76) Inventor: Chuang-Hua Chueh, Hsin Chu City (TW)

Correspondence Address: BIRCH STEWART KOLASCH & BIRCH, PO BOX 747, FALLS CHURCH, VA, 22040-0747, US

(21) Appl. No.: 10/776,538

(22) Filed: Feb. 12, 2004

(30) Foreign Application Priority Data
May 15, 2003 (TW) 092113164

(51) Int. Cl. H04N 1/04; H04N 1/047; H04N 1/12

(52) U.S. Cl. 358/474; 358/475; 358/496; 358/497; 358/498

(57) ABSTRACT

A scan method capable of enhancing scan quality includes the steps of: moving one of a document and a scan module by a predetermined distance from the other; stabilizing the movement of one of the document and the scan module and consequently making the document and the scan module relatively stationary to each other; illuminating the document with light rays from a light source, and receiving a stable image signal of the document by utilizing an image sensor of the scan module; and terminating the receiving operation of the image sensor and shutting off the light source after the image sensor has received the stable image signal for a first predetermined period of time. Therefore, a poor influence on the scan quality owing to the vibration of the scan module relative to the document may be avoided.

### BACKGROUND OF THE INVENTION

1. Field of the Invention

The invention relates to a scan method capable of enhancing scan quality, and more particularly to a scan method capable of avoiding any poor influence of the relative vibration of the document to the scan module on the san quality.

2. Description of the Related Art

In order to increase the scan speed a conventional scan device usually starts the exposure of an image sensor when a scan module is initially moving or when a document is originally being fed. That is, as the scan module in a flatbed scanner is beginning to move by a distance of a scan line, the image sensor in the scan module has started to receive optical signals of the document and continued receiving them for a predetermined period of time. On the other hand, for a sheet-fed scanner, the image sensor in the scan module starts to receive optical signals of the document at the time when the document is being fed and moving by a distance of a scan line.

FIG. 1 is a graph showing a relationship between position and exposure time for a conventional scan module. As shown in FIG. 1, the period when the document is moving from position D1 to position D2 is just from time T1 to T2, whereas the document remains stationary from time T2 to T3. The conventional scan-exposure cycle rests on the period from T1 to T3, as shown in the hatched area. A document or a scan module of a typical scanner is driven by a stepping motor, which has instantaneous unstable states, no matter how accurate in positioning the stepping motor is, as the stepping motor starts operation from the inert state or when the stepping motor stops from the dynamic state. However, owing to the mechanical structure limitation as mentioned above, vibrations will always occur when the document or the scan module is moving during the period from time T1 to time T2. If the scan-exposure operations are performed during the vibration state of the document, the scan quality will be adversely influenced. Such outcome is not acceptable to users who demand a higher scan quality.

### SUMMARY OF THE INVENTION

It is therefore an object of the invention to provide a scan method capable of enhancing scan quality.

Another object of the invention is to provide a scan method which facilitate a user to select between a standard-quality scan mode and a high-quality scan mode.

To achieve the above-mentioned objects, the invention provides a scan method capable of enhancing scan quality. The method includes the steps of: (a) moving one of a document and a scan module by a predetermined distance from the other; (b) stabilizing the movement of one of the document and consequently making the document and the scan module relatively stationary to each other; (c) illuminating the document with light rays from a light source, and receiving a stable image signal of the document by utilizing an image sensor of the scan module; and (d) terminating the receiving operation of the image sensor and shutting off the light source after the image sensor has received the stable image signal for a first predetermined period of time.

To achieve the above-mentioned objects, the invention also provides a scan method capable of enhancing scan quality. The scan method includes the steps of: (a) continually illuminating a document with light rays from the light source; (b) moving one of the document and a scan module by a predetermined distance from the other, and at the same time discarding an unstable image signal of the document by utilizing an image sensor of the scan module; (c) stabilizing the movement of one of the document and consequently making the document and the scan module relatively stationary to each other, and receiving a stable image signal of the document by utilizing the image sensor of the scan module; and (d) terminating the receiving operation of the image sensor after the image sensor has received the stable image signal for a first predetermined period of time. In addition, the invention also provides a scan method for the user to select a desired scan mode.

Accordingly, it is possible to avoid any poor influence of the relative vibration of the scan module to the document on the scan quality.

### BRIEF DESCRIPTION OF THE DRAWINGS

FIG. 1 is a graph showing a relationship between position and exposure time for a conventional scan module.

FIG. 2 is a graph showing a relationship between position and exposure time for a scan module of the invention.

FIG. 3 is a flow chart showing a scan method according to a first embodiment of the invention.

FIG. 4 is a flow chart showing a scan method according to a second embodiment of the invention.

FIG. 5 is a flow chart showing a scan method according to a third embodiment of the invention.

FIG. 6 is a flow chart showing a scan method according to a four embodiment of the invention.

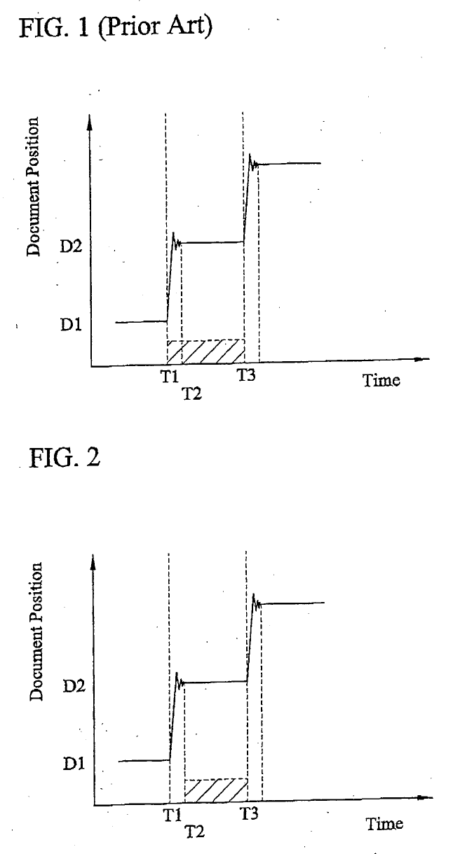

### DETAILED DESCRIPTION OF THE INVENTION

FIG. 2 is a graph showing a relationship between position and exposure time for a scan module of the invention. As shown in FIG. 2, the period when the document is moving from position D1 to position D2 is just from time T1 to T2, and the period when the document remains stationary is from time T2 to T3. The scan-exposure cycle of the invention rests on the period from T2 to T3, as shown in the hatched area. Since the document is relatively stationary to the scan module in the period from T2 to T3, a consistency of image quality may be obtained.

It is to be noted that although the document position is illustrated here, one of ordinary skill in the art may easily understand that the scan module position also may be utilized for illustration.

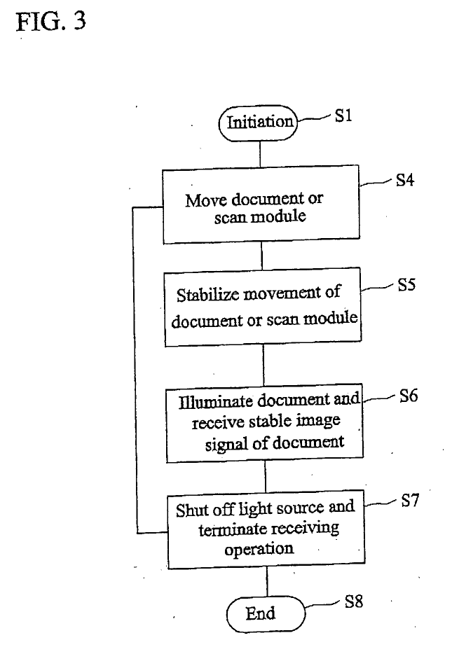

FIG. 3 is a flow chart showing a scan method according to a first embodiment of the invention. Referring to FIG. 3, the scan method of this embodiment includes the following steps.

In step S1, the method is initiated.

In step S4, one of a document and a scan module is moved by a predetermined distance from the other.

In step S5, the movement of one of the document and the scan module is stabilized to consequently make the document and the scan module relatively stationary to each other.

In step S6, the document is illuminated with light rays from a light source, and a stable image signal of the document is received by an image sensor of the scan module.

In step S7 the receiving operation of the image sensor is terminated and the light source is shut off after the image sensor has received the stable image signal for a first predetermined period of time.

In step S8, the method is ended.

It is to be noted that steps S4 to S7 may be repeated until all scan lines are finished.

In this embodiment, the light source has to be quickly switched on or off to provide stable light rays. For example, the light source may be a light-emitting diode.

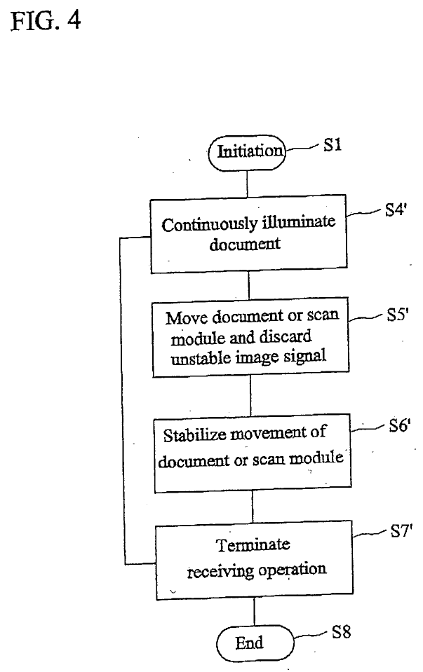

FIG. 4 is a flow chart showing a scan method according to a second embodiment of the invention. Referring to FIG. 4, the scan method of this embodiment includes the following steps.

In step S1, the method is initiated.

In step S4′, a document is continually illuminated with light rays from a light source.

In step S5′, one of the document and a scan module is moved by a predetermined distance from the other. Simultaneously, an unstable image signal of the document is discarded by utilizing an image sensor of the scan module.

In step S6′, the movement of one of the document and the scan module is stabilized to consequently make the document and the scan module relatively stationary to each other, and the image sensor of the scan module is utilized to receive a stable image signal of the document.

In step S7′, the receiving operation of the image sensor is terminated after the image sensor has received the stable image signal for a first predetermined period of time.

In step S8, the method is ended.

It is to be noted that steps S4′ to S7′ may be repeated until all scan lines are finished.

In this embodiment, it is not necessary for the light source to be quickly switched on or off and to quickly produce stable light rays as soon as the light source is turned on. Thus, a typical cold cathode fluorescent lamp may be used. In addition, since the image sensor has to discard the unstable image signal, the image sensor must have an electronic shutter through which the image sensor may discard or get the image signal of the document.

In order to meet various demands of various users, the invention also provides a scan method for enabling a user to select a desired scan mode, such as a high-quality scan mode or a standard-quality scan mode, for scanning the document.

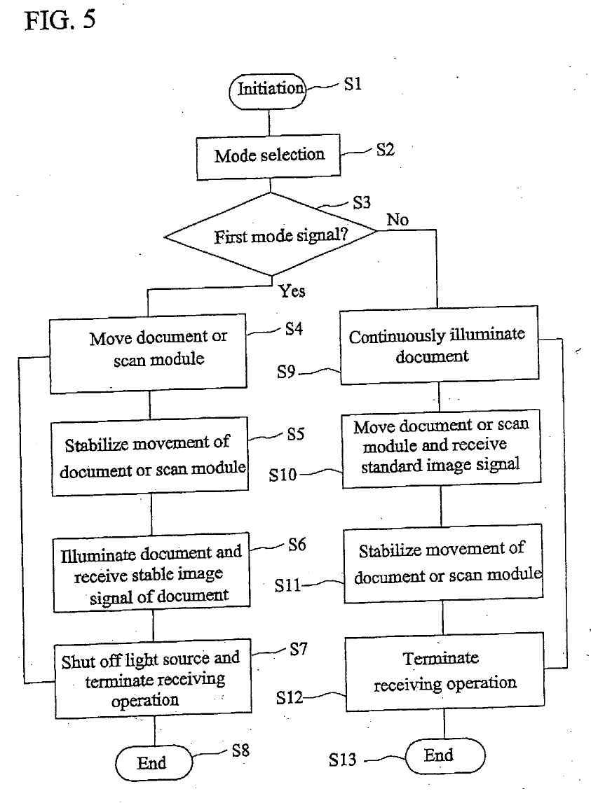

FIG. 5 is a flow chart showing a scan method according to a third embodiment of the invention. Referring to FIG. 5, the scan method of this embodiment includes the following steps.

In step S1, the method is initiated.

In step S2, a first mode signal or a second mode signal, which is selected by a user, is received, and a scan process of a high-quality scan mode or a standard-quality scan mode is performed according to the fist or second mode signal.

In step S3, it is judged that whether or not the signal is the first mode signal. If yes, the process skips to step S4, or otherwise the process skips to step S9.

Steps S4 to S8 are the same as those of the first embodiment, and detailed descriptions thereof will be omitted.

In step S9, the document is continually illuminated with light rays form the light source.

In step S10, one of the document and the scan module is moved by the predetermined distance from the other, and a standard image signal of the document is received by utilizing the image sensor of the scan module.

In step S11, the movement of one of the document and the scan module is stabilized to consequently make the document and the scan module relatively stationary to each other.

In step S12, the receiving operation of the image sensor is terminated after the image sensor has received the standard image signal for a second predetermined period of time.

In step S13, the method is ended.

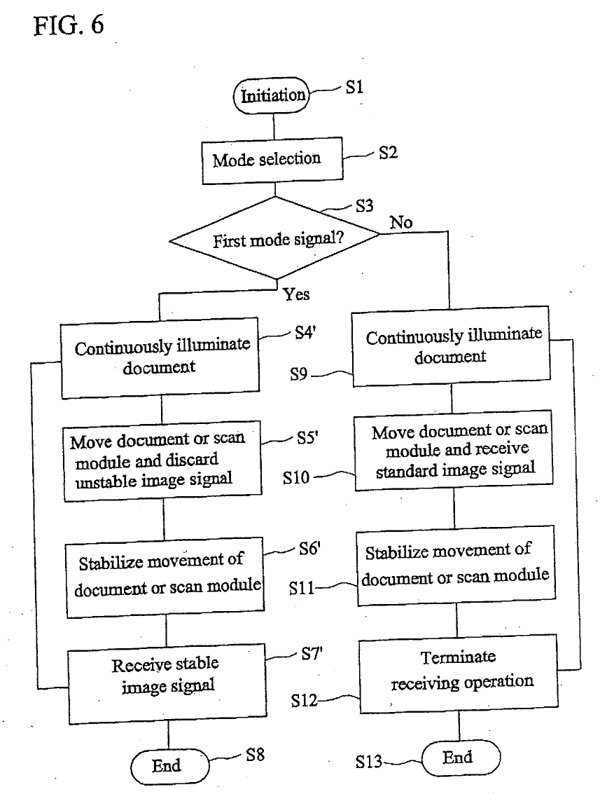

FIG. 6 is a flow chart showing a scan method according to a fourth embodiment of the invention. Referring to FIG. 6, the scan method of this embodiment includes the following steps.

In step S1, the process is started.

In step S2, a first mode signal or a second mode signal, which is selected by a user, is received, and a scan process of a high-quality scan mode or a standard-quality scan mode is performed according to the first or second mode signal.

In step S3, it is judged that whether or not the signal is the first mode signal. If yes, the process skips to step S4′, or otherwise the process skips to step S9.

Steps S4′ to S8 are the same as those of the second embodiment, and detailed descriptions thereof will be omitted.

Steps S9 to S13 are the same as the third embodiment, and detailed descriptions thereof will be omitted.

According to the scan method of the invention, the image sensor does not receive the unstable image signal when the image sensor is vibrating relative to the document. Thus, the obtained image quality is relatively high. Although the method may require an extended period of the scan-exposure time to optimize the scan brightness, it is acceptable to slightly elongate the scan time in order to obtain a greatly improved image quality. Alternatively, in the circumstance that the exposure time is not elongated, the image signal received by the image sensor contains only the stable image data. Although the exposure time may be reduced, the overall scan effect is sharper than that including the unstable image signal received during the period of time. That is, the adverse influence of adding the unstable image signal on the image data of the whole scan line is greater than that of removing the unstable signal and shortening the exposure time. Accordingly, the quality of the latter is higher than that of the former.

In addition, the invention also provides a mechanism for the user to choose between the high-quality scan mode and the standard-quality scan mode. Thus, the method may satisfy various users having specific demands on the scan speed and scan quality.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A scan method capable of enhancing scan quality, the scan method comprising the steps of:
(a) moving one of a document and a scan module by a predetermined distance from the other;
(b) stabilizing the movement of one of the document and the scan module and consequently making the document and the scan module relatively stationary to each other;
(c) illuminating the document with light rays from a light source, and receiving a stable image signal of the document by utilizing an image sensor of the scan module; and
(d) terminating the receiving operation of the image sensor and shutting off the light source after the image sensor has received the stable image signal for a first predetermined period of time.

2. The scan method according to claim 1, wherein the step (a) comprises a step of:
feeding the document to generate the predetermined distance from the stationary scan module.

3. The scan method according to claim 1, wherein the step (a) comprises a step of:
moving the scan module by the predetermined distance from the stationary document.

4. The scan method according to claim 1, wherein the light source is a light-emitting diode.

5. The scan method according to claim 1, further comprising the steps of:
receiving a first mode signal or a second mode signal selected by a user;
executing steps (a) to (d) when the first mode signal is received; and
executing the following steps when the second mode signal is received:
(a1) continually illuminating the document with the light rays from the light source;
(b1) moving one of the document and the scan module by the predetermined distance from the other, and receiving a standard image signal of the document by utilizing the image sensor of the scan module;
(c1) stabilizing the movement of one of the document and the scan module and consequently making the document and the scan module relatively stationary to each other; and
(d1) terminating the receiving operation of the image sensor after the image sensor has received the standard image signal for a second predetermined period of time.

6. A scan method capable of enhancing scan quality, the scan method comprising the steps of:
(a) continually illuminating a document with light rays from a light source;
(b) moving one of the document and a scan module by a predetermined distance from the other, and at the same time discarding an unstable image signal of the document by utilizing an image sensor of the scan module;
(c) stabilizing the movement of one of the document and the scan module and consequently making the document and the scan module relatively stationary to each other, and receiving a stable image signal of the document by utilizing the image sensor of the scan module; and
(d) terminating the receiving operation of the image sensor after the image sensor has received the stable image signal for a first predetermined period of time.

7. The scan method according to claim 6, wherein the step (b) comprises a step of:
feeding the document to generate the predetermined distance from the stationary scan module.

8. The scan method according to claim 6, wherein the step (b) comprises a step of:
moving the scan module by the predetermined distance from the stationary document.

9. The scan method according to claim 6, wherein the image sensor has an electronic shutter.

10. The scan method according to claim 6, further comprising the steps of:
receiving a first mode signal or a second mode signal selected by a user;
executing steps (a) to (d) when the first mode signal is received; and
executing the following steps when the second mode signal is received:
(a1) continually illuminating the document with the light rays from the light source;
(b1) moving one of the document and the scan module by the predetermined distance from the other, and receiving a standard image signal of the document by utilizing the image sensor of the scan module;
(c1) stabilizing the movement of one of the document and the scan module and consequently making the document and the scan module relatively stationary to each other; and
(d1) terminating the receiving operation of the image sensor after the image sensor has received the standard image signal for a second predetermined period of time.
